(19) United States
(12) Patent Application Publication
(10) Pub. No.: US 2020/0196395 A1
(43) Pub. Date: Jun. 18, 2020

(54) HEATING DEVICE AND METHOD FOR PRODUCTION THEREOF

(71) Applicant: WEBASTO SE, Stockdorf (DE)

(72) Inventors: Martin ZOSKE, Stockdorf (DE); Michael SCHWANECKE, Stockdorf (DE); Volodymyr ILCHENKO, Stockdorf (DE); Bengt MEIER, Stockdorf (DE); Christoph JÖRG, Stockdorf (DE); Vitali DELL, Stockdorf (DE)

(73) Assignee: Webasto SE, Stockdorf (DE)

(21) Appl. No.: 16/614,921

(22) PCT Filed: May 23, 2018
(86) PCT No.: PCT/EP2018/063508

§ 371 Date: Nov. 19, 2019

(30) Foreign Application Priority Data
May 24, 2017 (DE) 10 2017 111 373.8
May 24, 2017 (DE) 10 2017 111 378.9
Jul. 6, 2017 (DE) 10 2017 115 148.6
Sep. 12, 2017 (DE) 10 2017 121 041.5

(51) Int. Cl. H05B 3/28; H05B 3/18; H05B 3/14; B60H 1/22; B29C 45/00; B29C 45/14

(52) U.S. Cl. CPC H05B 3/286; H05B 3/18; H05B 3/146; B60H 1/2225; B29C 45/0001; B60H 2001/00128; H05B 2203/023; H05B 2203/024; H05B 2203/017; H05B 2203/02; B29K 2995/0005; B29C 45/14639

(57) ABSTRACT

A method for producing an electric heating device, preferably fluid- or air-heating device, in particular for a motor vehicle, wherein at least one conductive polymer structure is produced by primary forming, said polymer structure containing a polymer component and a conductive component, in particular carbon component, wherein fluid channels for conducting the fluid to be heated are introduced into the polymer structure during the primary-forming manufacturing.

### CROSS-REFERENCE TO RELATED APPLICATIONS

This application represents the national stage entry of PCT International Patent Application No. PCT/EP2018/063508 filed on May 23, 2018 and claims priority to German Patent Application No. DE 10 2017 111 373.8 filed May 24, 2017, to German Patent Application No. DE 10 2017 111 378.9 filed May 24, 2017, German Patent Application No. DE 10 2017 115 148.6 filed Jul. 6, 2017, and German Patent Application No. DE 10 2017 121 041.5 filed Sep. 12, 2017. The contents of each of these applications are hereby incorporated by reference as if set forth in their entirety herein.

### DESCRIPTION

The disclosure relates to a heating device, in particular for a motor vehicle, and to a method for producing the same.

Electric heating devices, in particular air-heating devices (in particular those used in mobile applications), are often based on ceramic heating elements having a comparatively highly temperature-dependent electrical resistance, as a result of which self-regulation of the heating output is made possible. These resistors are usually ceramic PTC elements (PTC for Positive Temperature Coefficient). The latter are generally connected to heat exchanger surfaces of aluminium sheet and are also electrically contacted thereby. A PTC element comprises a PTC thermistor, that is to say a temperature-dependent resistor having a positive temperature coefficient, which conducts the electrical current better at low temperatures than at high temperatures.

Disadvantages of conventional heating devices, in particular air-heating devices having ceramic PTC elements, are, inter alia, complex production as a result of comparatively complicated heat exchanger manufacture and the incorporation of the ceramic elements, sorting of the ceramic elements that is usually necessary on account of manufacturing tolerances, a comparatively unfavourable power density in a heating element/heat exchanger composite assembly as a result of local heat generation, a comparatively great limitation of a maximum heating power as a result of a thickness of the PTC material (on account of a limited heat dissipation from the ceramic) and a comparatively high risk of short-circuits, in particular on account of a small geometric spacing of components having a high voltage potential.

It is an object of the invention disclosure to propose a method for producing a heating device, in particular air- or fluid-heating device, wherein effective heating of the fluid is made possible. It is also the intention to propose a corresponding air-heating device.

This object is achieved in particular by a method according to Claim 1.

In particular, the object is achieved by a method for producing an electric heating device, preferably fluid- or air-heating device, preferably for a vehicle, in particular for a motor vehicle, wherein at least one conductive polymer structure is produced by primary forming, wherein the polymer structure contains a polymer component and a conductive component, in particular carbon component, wherein fluid channels (openings) for conducting the fluid to be heated are introduced into the polymer structure during the primary-forming manufacturing.

A basic concept of the invention disclosure is that of producing a (conductive) polymer structure for heating up fluid (in particular water, preferably cooling water or air, preferably heating air for an interior space, in particular of a vehicle) in a heating device, preferably fluid- or air-heating device, wherein integrated openings for conducting the fluid (fluid channels) are produced or introduced during a primary forming operation. In this way, a heating device, preferably fluid- or air-heating device, which enables efficient operation may be realized easily and efficiently.

Preferably, the polymer structure has a multiplicity of fluid channels, e.g. more than 10 fluid channels.

Preferably, the polymer structure is formed as a one-piece, in particular monolithic, structure.

Preferably, exactly one or alternatively a plurality of polymer structures may be provided.

The primary forming operation may comprise a casting operation, in particular injection moulding and/or die-casting operation, a pressing operation, in particular extrusion and/or press-forming operation, and/or a foaming (expanding) operation.

Fundamentally, primary forming is understood to mean a manufacturing method in which a (solid) body is produced (which in particular has a geometrically defined shape) from a shapeless and/or deformable (e.g. fluid, pasty, pulpy or plastically deformable) substance.

An extent of the polymer structure (in the direction of flow) preferably amounts to at least 5 mm, more preferably at least 10 mm.

The polymer structure is preferably dimensionally stable per se, that is to say it also keeps its shape if further components of the heating device are removed (or have not yet been added or, in the case of integrated further components, if the latter were not provided, which can be determined by producing a corresponding comparative object without the further components). In particular, a dimensionally stable configuration does not exclude the fact that the polymer structure is elastically and/or plastically deformable when exposed to external forces.

A tool for carrying out the primary forming (e.g. injection moulding tool) preferably has manufacturing structures that appropriately correspond to the fluid channels (e.g. corresponding projections).

During the primary forming, at least one electrical connection element, such as preferably a metal wire, metal grid, metal sheet and/or metal sheet strip, may be connected to the polymer structure, preferably embedded in the polymer structure. A connection is understood in particular to mean a material-bonded (firm) connection. Alternatively or in addition, a form-fitting connection (e.g. by corresponding projections or recesses provided on the connection element) is provided. Embedding in the polymer structure is understood in particular to mean that more than just one side of the at least one electrical connection element is in contact with the polymer structure, and/or that at least 50% of the electrical connection element is covered by the polymer structure.

Preferably, at least one (the at least one) electrical connection element is arranged in (and/or inserted into) a shaping tool, in particular injection moulding tool, before the primary forming, in particular injection moulding. In particular, connection lines of metal sheet strips and/or wires and/or strands and/or a mesh and/or the like may be inserted into the shaping tool (injection moulding tool) already before the primary forming (e.g. injection moulding).

The abovementioned object is also achieved by an electric heating device, preferably fluid- or air-heating device, in particular for a vehicle, preferably for a motor vehicle, more preferably produced by the above method, comprising at least one conductive polymer structure, wherein the polymer structure contains a (possibly non-conductive) polymer component and a conductive (filler) component, in particular carbon component, wherein the polymer structure has fluid channels (openings) for conducting the fluid to be heated, wherein the fluid channels are introduced by primary forming during the manufacturing of the polymer structure (which can be determined in the finished product in particular by means of an examination of the surface of fluid channel walls).

The electric fluid-heating device, in particular fluid- or air-heating device, preferably has at least one electrical connection element, such as preferably a metal wire, metal grid, metal sheet and/or metal sheet strip.

The polymer structure preferably has a grid, honeycomb or network structure.

Cross sections of the fluid channels in the polymer structure may amount to at least 5%, preferably at least 10%, more preferably at least 20% of a total cross section of the polymer structure. Furthermore, cross sections of the fluid channels in the polymer structure may amount to at most 80% of a total cross section of the polymer structure.

The conductive component, in particular carbon component, may be present in particle form and/or as a carbon backbone.

The conductive component, in particular carbon component, may be formed and/or arranged such that it enables a flow of current, e.g. in particle form (where the particles correspondingly touch or lie close to one another) and/or as a (carbon) backbone. The conductive component may comprise metal particles and/or metal fibres. The carbon component may be present in the form of carbon black and/or graphite and/or graphene and/or carbon fibres and/or carbon nanotubes and/or fullerenes.

The polymer structure may have an electrically insulating polymer component.

Preferably, the polymer structure comprises at least 6, more preferably at least 10, still more preferably at least 40 fluid channels.

The abovementioned object is also achieved by a method for operating a fluid-heating device, in particular fluid- or air-heating device of the type described above or produced by the method of the type described above, wherein fluid flows through the fluid channels and is heated in the process.

The abovementioned object is also achieved by the use of a fluid-heating device, in particular fluid- or air-heating device of the type described above or produced by the above-described method, for heating air, in particular in a vehicle, preferably motor vehicle, more preferably for an interior space of a motor vehicle.

The abovementioned object is also achieved by a vehicle comprising a fluid-heating device, in particular fluid- or air-heating device of the type described above or produced by the above-described method.

The polymer structure is preferably a conductive structure having PTC behaviour.

Cross sections of at least one or more or all fluid channels may be polygonal, in particular quadrilateral, preferably rectangular (more preferably square), or oval, in particular elliptical, preferably circular. A cross section within a fluid channel may vary or be constant (over its length). Cross sections of various fluid channels may also deviate from one another or be identical.

A protective layer (coating or sealing) may be provided on the entire heating device or at least exposed regions of the polymer structure to protect against mechanical damage, moisture and/or short-circuits.

The term “conductive” with respect to the polymer structure (or plastic component) is to be understood as an abbreviation of “electrically conductive”.

The polymer structure may be formed as a polymer sheet (having corresponding openings or fluid channels).

Polymer component and conductive (carbon) component are preferably mixed with one another and/or interwoven. For example, the polymer component may form a (skeleton-like) backbone, in which the conductive component is received or vice versa.

Preferably, the polymer structure consists to an extent of at least 5% by weight, preferably at least 10% by weight, still more preferably at least 15% by weight, still more preferably at least 20% by weight and/or less than 50% by weight of carbon (possibly without taking into account a carbon content of the polymer per se), or of the carbon component, such as e.g. the carbon particles.

Preferably, the carbon component consists to an extent of at least 50% by weight, more preferably at least 70% by weight of carbon.

The polymer component is in particular in the form of an electrically insulating polymer component.

In embodiments, the polymer component may have a first polymer subcomponent based on ethylene acetate (copolymer) and/or ethylene acrylate (copolymer) and/or comprise a second polymer subcomponent based on polyolefin, in particular polyethylene and/or polypropylene, and/or polyester and/or polyamide and/or fluoropolymer. The term “subcomponent” is intended in particular to be used here to differentiate between first and second polymer subcomponents. The respective subcomponent may form the polymer component either partially or else fully. The ethylene acrylate may be ethyl methyl acrylate or ethylene ethyl acrylate. The ethylene acetate may be ethylene vinyl acetate. The polyethylene may be HD (high-density) polyethylene, MD (medium-density) polyethylene or LD (low-density) polyethylene. The fluoropolymer may be PFA (copolymer of tetrafluoroethylene and perfluoropropyl vinyl ester), MFA (copolymer of tetrafluoroethylene and perfluorovinyl ester), FEP (copolymer of tetrafluoroethylene and hexafluoropropylene), ETFE (copolymer of ethylene and tetrafluoroethylene) or PVDF (polyvinylidene fluoride).

In embodiments, the first polymer subcomponent may be formed as described in WO 2014/188190 A1 (as first electrically insulating material). The second polymer subcomponent may likewise be formed as described in WO 2014/188190 A1 (as second electrically insulating material).

The polymer structure(s) may be (electrically) contacted by at least one metal structure, preferably an (in particular curved) metal sheet, preferably copper sheet, and/or metal strip and/or metal wire and/or metal grid.

Alternatively or in addition, the metal structure (or corresponding electrodes) may be printed e.g. onto the substrate and/or the polymer coating (and/or applied by vapour deposition, precipitation and/or coating).

The polymer structure(s) and/or a corresponding substance to be shaped (e.g. paste) for its production may comprise at least one polymer (as, in particular, crystalline binder), preferably based on at least one olefin; and/or at least one copolymer of at least one olefin and at least one monomer that can be copolymerized therewith, e.g. ethylene/acrylic acid and/or ethylene/ethyl acrylate and/or ethylene/vinyl acetate; and/or at least one polyalkenamer (polyacetylene and/or polyalkenylene), such as e.g. polyoctenamer; and/or at least one, in particular melt-deformable, fluoropolymer, such as e.g. polyvinylidene fluoride and/or copolymers thereof.

In general, the polymer structure or a substance (paste) used for producing the polymer structure may be formed as described in DE 689 23 455 T2. This also applies in particular for the production and/or specific composition thereof. For example, this also applies for possible binders (in particular in accordance with page 4, 2nd paragraph and page 5, 1st paragraph of DE 689 23 455 T2) and/or solvents (in particular in accordance with page 5, 2nd paragraph and page 6, 2nd paragraph of DE 689 23 455 T2).

The polymer structure is preferably a PTC thermistor. As a result, self-regulation of the temperature can be made possible, which simplifies the control and in particular increases the safety during operation.

By correspondingly selecting the geometry of the polymer structure (of the polymer body) specifically with respect to the fluid channels (openings) for the fluid to be heated, a high component surface area can be realized that, on account of a good convective heat transfer, enables a high heating power in a small structural space.

Similarly, as a result of a corresponding geometry or surface area of metallic connection elements (connection lines), the electrical resistance during transfer into the polymer structure (or a polymer material of the polymer structure) can be minimized, and the risk of deterioration of the contact over the lifetime can be reduced.

To improve contact between polymer structure and electrical connection elements, the latter may be roughened (e.g. by sand-blasting) and/or holes and/or undercuts may be introduced into the (respective) connection element. Alternatively or in addition, woven wire mesh and/or knitted wire mesh may be provided as connection elements.

The polymer structure may possibly not only perform the function of a heating conductor, but as an (integral) component may simultaneously enable further functions, in particular form a framework or connecting surfaces for the heating device.

Overall, an easy, cost-effective production can be realized by a small number of process steps (that can be easily automated) and with cost-effective materials. In conjunction with a small structural space requirement, a high heating power is possible. The fluid to be heated in particular experiences only a comparatively small loss of pressure. Furthermore, a high flexibility can be achieved with regard to the structure, in particular in relation to the dimensions, supply voltages and geometric dimensions.

The fluid-heating device, in particular fluid- or air-heating device, is preferably designed for operation in the low-voltage range (e.g. 100 volts or 60 volts).

The heating device can be configured for operation with alternating or direct current. A pulse-width-modulated supply is possible.

An electrically insulating material is understood to mean in particular a material that at room temperature (25° C.) has an electrical conductivity of less than

10-1 S·m−1 (possibly less than 10-8 S·m−1). Correspondingly, an electrical conductor or an electrically conducting material (or coating) is understood to mean a material having an electrical conductivity of preferably at least 10 S·m−1, more preferably at least 103 S·m−1 (at room temperature of, in particular, 25° C.).

Further embodiments emerge from the dependent claims.

The invention disclosure is described below with reference to an exemplary embodiment that is explained in more detail with reference to the appended figures. In the figures:

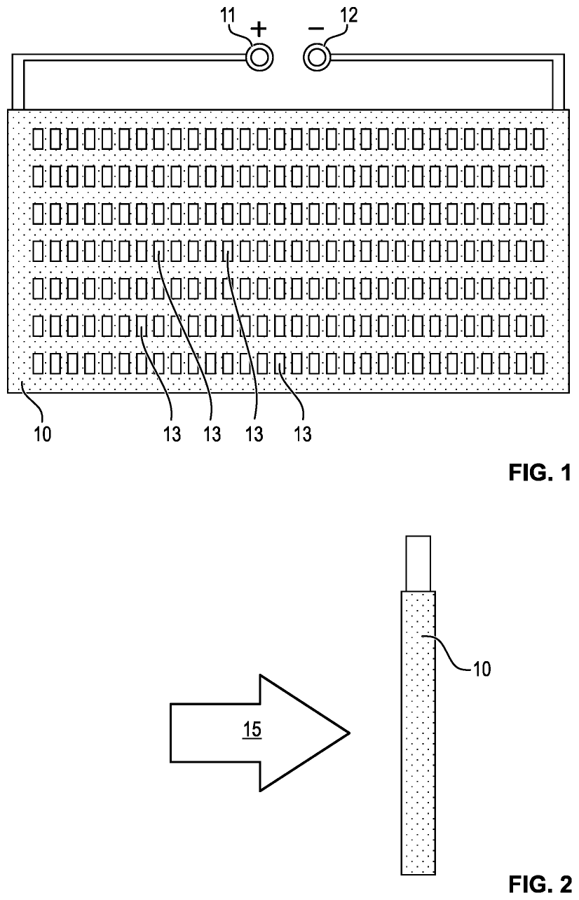

FIG. 1 shows a schematic front view of an electric air-heating device according to the invention;

FIG. 2 shows a side view of the air-heating device according to FIG. 1;

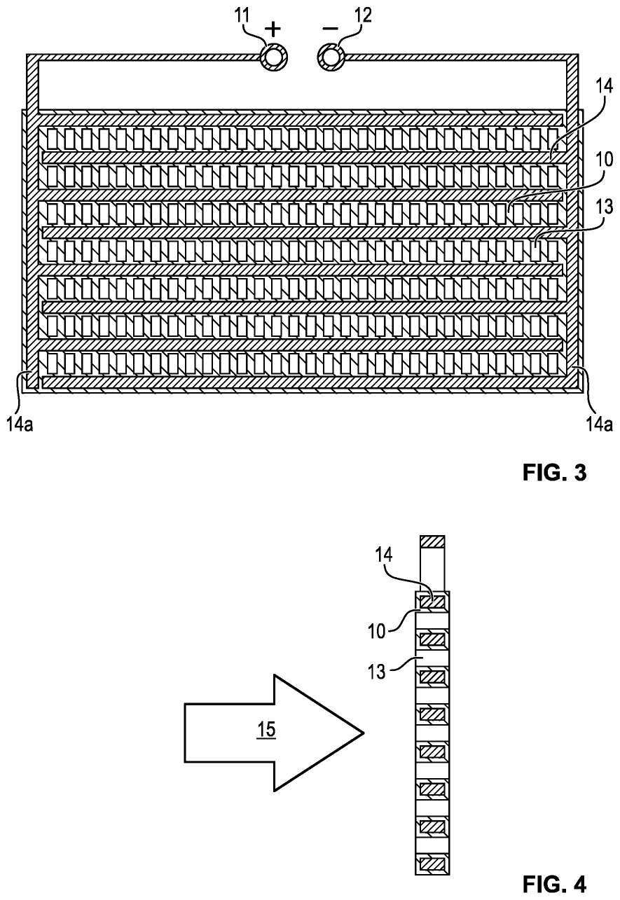

FIG. 3 shows a sectional representation of the heating device according to FIG. 1; and

FIG. 4 shows a further sectional view of the air-heating device according to FIG. 1.

In the following description, the same reference numerals are used for identical and functionally identical parts.

FIG. 1 shows a schematic front view of an electric air-heating device according to the invention. The air-heating device has a polymer structure 10 and electrical contacts 11 and 12. The polymer structure 10 has a multiplicity of fluid channels 13 which here (optionally) have a rectangular cross section. The fluid channels 13 are arranged (regularly) in a plurality of columns and rows (this is not necessary).

In the sectional views according to FIGS. 3 and 4, electrical connection elements 14, 14a (e.g. connection bars or sheet strips) are provided which are embedded in the polymer structure 10 (see also FIG. 4). The connection elements 14a connect the connection elements 14 to the contacts 11, 12.

The air flow is schematically outlined by the arrow 15 in FIGS. 2 and 4.

As can also be seen in FIG. 3, the electrical connection elements 14 (connection bars) are connected to one another, such that an electrical connection is ensured (via the electrical contacts 11, 12).

The polymer structure 10 is a polymer structure based on polymer having a carbon content. The polymer structure has PTC behaviour.

The electrical connection elements 14 are preferably of metal.

The electrical supply may in particular take place via direct current.

At this point it should be noted that all of the parts described above, viewed individually and in any combination, in particular the details illustrated in the drawings, are claimed as essential to the invention. Amendments thereto are familiar to the person skilled in the art.

### LIST OF REFERENCE SIGNS

10 Polymer structure
11 Electrical contact
12 Electrical contact
13 Fluid channel
14 Electrical connection element
15 Arrow

1. Method for producing an electric heating device, preferably fluid- or air-heating device, in particular for a motor vehicle, wherein at least one conductive polymer structure is produced by primary forming, said polymer structure containing a polymer component and a conductive component, in particular carbon component, wherein fluid channels for conducting the fluid to be heated are introduced into the polymer structure during the primary-forming manufacturing.

2. Method according to claim 1,
wherein
the primary forming operation comprises: a casting operation, in particular injection moulding and/or die-casting operation, a pressing operation, in particular extrusion and/or press-forming operation, and/or a foaming operation.

3. Method according to claim 1,
wherein
during the primary forming, at least one electrical connection element is connected to the polymer structure.

4. Method according to claim 1,
wherein
at least one/the at least one electrical connection element is arranged in a shaping tool before the primary forming.

5. Method according to claim 1,
wherein
the polymer structure forms a grid, honeycomb or network structure.

6. Electric heating device comprising at least one conductive polymer structure, wherein the polymer structure contains a polymer component and a carbon component, wherein the polymer structure has fluid channels for conducting the fluid to be heated, wherein the fluid channels are introduced by primary-forming manufacturing of the polymer structure.

7. Heating device according to claim 6,
wherein
at least one electrical connection element is connected to the polymer structure.

8. Heating device according to claim 6,
wherein
the polymer structure comprises a grid, honeycomb or network structure.

9. Heating device according to claim 6,
wherein
cross sections of the fluid channels in the polymer structure amount to at least 5% and/or amount to at most 80% of a total cross section of the polymer structure.

10. Heating device according to claim 6,
wherein
the carbon component is present in particle form and/or as a carbon backbone and/or
is present in the form of carbon black and/or graphite and/or graphene and/or carbon fibres and/or carbon nanotubes.

11. Heating device according to claim 6,
wherein
the polymer structure has an electrically insulating polymer component.

12. Heating device according to claim 6,
wherein
the polymer structure comprises at least 6 fluid channels.

13. Method for operating a heating device according to claim 6, wherein fluid flows through the fluid channels and is heated in the process.

14. (canceled)

15. Method according to claim 3 wherein the at least one electrical connection element is a metal wire, metal grid, metal bar, metal sheet and/or metal sheet strip and is embedded in the polymer structure.

16. Method according to claim 4, wherein the shaping tool is an injection moulding tool.

17. Heating device according to claim 7, wherein the at least one electrical connection element is a metal wire, metal grid, metal bar, metal sheet and/or metal sheet strip, and is embedded in the polymer structure.

18. Heating device according claim 9, wherein cross sections of the fluid channels in the polymer structure amount to at least 20% of a total cross section of the polymer structure.

19. Heating device according to claim 12, wherein the polymer structure comprises at least 40 fluid channels.

20. Heating device according to claim 12, wherein the polymer structure comprises at least 10 fluid channels.

21. Method for operating a heating device according to claim 13 wherein the fluid is air.
